(19) United States
(12) Patent Application Publication
(10) Pub. No.: US 2015/0320269 A1
(43) Pub. Date: Nov. 12, 2015

(54) BATHROOM TOOL WITH AESTHETIC IMPLEMENT

(71) Applicant: Wesley Ward, JR., St. Clair Township, MI (US)

(72) Inventor: Wesley Ward, JR., St. Clair Township, MI (US)

(21) Appl. No.: 14/709,123

(22) Filed: May 11, 2015

Related U.S. Application Data
(60) Provisional application No. 61/991,985, filed on May 12, 2014.

(51) Int. Cl. A47K 11/10; B25G 1/04; E03C 1/308; B44F 7/00

(52) U.S. Cl. CPC A47K 11/10; B44F 7/00; B25G 1/04; E03C 1/308

(57) ABSTRACT

A bathroom tool comprises an elongate handle, a tool implement, such as a toilet plunger or brush, an aesthetic implement removably coupled to the top of the elongate handle, and a base piece capable of receiving the tool implement. The aesthetic implement improves the visual appeal of the disclosed tool by incorporating one or more decorative elements thereon. The tool implement may be a toilet plunger, a toilet brush, or a combination thereof. An aesthetic adornment comprises a tool implement and aesthetic implement and may be retrofit onto an existing bathroom tool.

### CROSS-REFERENCE TO RELATED APPLICATIONS

The present disclosure claims priority under 35 U.S.C. §119 under pending U.S. Provisional Patent Application Ser. No. 61/991,985, filed on May 12, 2014, the disclosure of which is incorporated by reference.

### FIELD OF THE DISCLOSURE

The present disclosure relates to a bathroom tool, and more particularly to a bathroom tool comprising a combination toilet plunger and toilet brush implement and having one or more aesthetic elements disposed about it.

### BACKGROUND

The bathroom and the toilet are amongst the most frequently visited locations and fixtures used in any building, respectively. Given the frequency of trips one makes to use a toilet throughout any given day, proper toilet maintenance is a necessity. That is, as the toilet is one of the most frequently used fixtures in a given day, it is crucial that it be maintained in proper working order and in a hygienic appearance. Use of a toilet may result in an obstruction of the plumbing, or may cause the toilet bowl itself to become soiled.

To remove such an obstruction, a toilet plunger is used by repeatedly applying a pressurized force against the plumbing, which force acts on the obstruction and causes it to move and thus exit through the plumbing. To remove such a soiling, a toilet brush is used to clean the various portions within the toilet bowl, either using bristles or some other means, which toilet brush is capable of conforming with the shape of toilet bowl to clean even the hard-to-reach places therein. The toilet plunger and toilet brush are both crucial tools for the proper functioning of a toilet; however, necessitating separate tools is often cumbersome and, at the very least, requires twice as much storage space when not in use and twice as much time to utilize.

A solution for combining multiple bathroom tools into a single device is shown in U.S. Pat. No. 7,430,779, which discloses a combination toilet brush and plunger bathroom tool. A brush element is located at the end of an elongate handle within a plunger element, which plunger element is removably disposed about said handle via a receiving base portion that interlocks with the top side of the brush element. When a user requires the plunger element thereof, he or she may simply pick up the tool without any further work needed. When the user requires the brush element thereof, he or she must disengage the plunger element by unlocking the plunger base from the brush element. However, this design requires the user to take extra steps in securing or removing the plunger base to or from the brush element, and may result in soiled materials entering the plunger base via the brush element.

Further, toilet tools, such as a toilet plunger or toilet brush, are often stored on the floor of a bathroom outside of cabinetry or other storage units and nearby the toilet for convenience. While keeping a toilet tool in place sight may be functionally efficient, it generally will do little by way of improving or increasing the appearance or visual appeal of a bathroom. That is, homeowners often wish to dress their bathrooms to look fancy or visually appealing to others, which appeal helps to make the bathroom seem more inviting and even more hygienic. Nevertheless, leaving bathroom tools in place sight may negatively interfere with that goal, and will at least detract from the otherwise visually appealing nature and design of the room.

A solution for increasing the aesthetic appeal of a bathroom tool is taught in U.S. Pat. No. 7,058,993, which invention relates to a flora integrated cover for toilet tools. A base surrounds the bottom portion of the bathroom tool and supports a cover, which cover includes and supports the growth of vegetation, such as flowers, thereon. Still, while this disclosure provides a more appealing look to the utilized bathroom tool, it fails to hide the elongate handle of the bathroom tool, which protrudes upwardly through the center of the base and cover, requires the user to awkwardly remove the multi-component base and cover each time he or she needs to use such bathroom tool, and is limited to a flora cover.

Notwithstanding the potential benefits prescribed by the aforementioned references, it is apparent that the prior art fails to disclose a bathroom tool comprising a combination toilet plunger and toilet brush device that independently operates as either a plunger or brush without the need for other mechanisms, and further includes an aesthetic implement for improving the visual appeal of the bathroom tool that does not require significant displacement to use the tool.

Thus, while existing solutions may teach a modified bathroom tool or a bathroom tool disposed within a decorative cover, various drawbacks, including those mentioned above, remain.

Consequently, there exists a need for a bathroom tool that may comprise a multi-tool combination without the need to uncouple tool implements, and which comprises an aesthetic implement and a base piece that cover the top and bottom portions thereof, respectively, in order to improve the aesthetic quality and appearance of the bathroom tool.

### SUMMARY OF THE INVENTION

In view of the foregoing disadvantages of the prior art, a bathroom tool configured to include all the advantages of the prior art and to overcome the drawbacks inherent therein is provided. It is an object of the present disclosure to provide a bathroom tool that overcomes the shortcomings known in the art. It is further an object of the present disclosure to provide a bathroom tool having a toilet plunger and a toilet brush each comprised thereon for plunging or cleaning a toilet, respectively, without the need for other devices or tools and without requiring additional mechanisms to switch between the same. It is further an object of the present disclosure to provide a bathroom tool having an aesthetic implement for improving the visual appeal thereof by incorporating one or more attractive or visually-stimulating decorative elements along with the bathroom tool while providing ease of access to the bathroom tool at all times.

In an embodiment, a bathroom tool according to the present disclosure comprises an elongate handle, a tool implement, an aesthetic implement, and a base piece.

The elongate handle is any elongate structure capable of being grasped by a human user having a first end and a second end. The tool implement may comprise either or both of a toilet plunger and a toilet brush, and in any event is disposed on a second end of the elongate handle. The aesthetic implement is removably coupled to the first end of the elongate handle and provides an aesthetic feature for improving the appearance of the bathroom tool. A base piece receives at least a portion of the bathroom tool (e.g., the tool implement) and maintains the bathroom tool in a substantially upright orientation when in non-use.

The aesthetic implement may comprise one or more of a flower, a bouquet of flowers, a potpourri container, a decorative tray, a football, a baseball, a soccer ball, a basketball, a trophy, and an art object (for example, a glasswork, pottery, metalwork, or other artistic item). The base piece may generally comprise a feature representative of or corresponding to the utilized aesthetic implement, such as a vase, a decorative container or stand, a trophy stand, and a sports memorabilia stand. Furthermore, and although the present disclosure makes reference to certain kinds of embodiments of the aesthetic implement and/or base piece, it is understood and acknowledged that additional alternatives may also be contemplated herewith.

Further alternatives and embodiments are herein contemplated. For example, wherein the elongate handle is adjustable in length by way of one of a telescoping feature and an accordioning feature, or wherein, in an embodiment wherein the tool implement comprises a toilet brush, the disclosure further includes a brush cover. It is further noted that the elongate handle may support ancillary functionality, such as the receipt and storage of rolls of toilet paper, and further that an attachment device may be removably coupled to a portion of the bathroom tool for receiving and storing rolls of toilet paper, as well.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawings and detailed description in which there are illustrated and described exemplary embodiments of the present disclosure.

### DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 shows an exemplary depiction of the disclosed bathroom tool in accordance with an exemplary embodiment of the present disclosure;

FIG. 2 shows an exemplary depiction of the removable coupling of the aesthetic implement to the elongate handle in accordance with an exemplary embodiment of the present disclosure; and

FIG. 3 shows an exemplary depiction of the tool implement comprising a combination tool including a brush cover and slidable engagement of the toilet plunger with respect to the toilet brush in accordance with an exemplary embodiment of the present disclosure.

Like reference numerals refer to like parts throughout the description of several views of the drawings.

### DETAILED DESCRIPTION OF THE DISCLOSURE

The best mode for carrying out the present disclosure is presented in terms of its preferred embodiments, herein depicted in the accompanying figures. The preferred embodiments described herein detail for illustrative purposes are subject to many variations.

It is understood that various omissions and substitutions of equivalents are contemplated as circumstances may suggest or render expedient, but are intended to cover the application or implementation without departing from the spirit or scope of the present disclosure.

The terms “a” and “an” herein do not denote a limitation of quantity, but rather denote the presence of at least one of the referenced items.

The present disclosure recites a bathroom tool for increasing efficiency and improving visual appeal within the bathroom. The disclosed bathroom tool comprises an elongate handle, a tool implement at a lower end, or second end, of the elongate handle, and an aesthetic implement at an upper end, or first end, of the elongate handle. When not in use, the bathroom tool may be seated within a base piece that securely retains the bathroom tool in an upright position until it is next needed. The aesthetic implement improves the visual appeal of the bathroom tool by representing the tool as another item, such as a bouquet of flowers. The base piece is generally a retention mechanism for the tool; however, in an embodiment the base piece may also comprise an aesthetic quality that matches or corresponds to the aesthetic implement (e.g., wherein the aesthetic implement is a bouquet of flowers, the base piece may be a vase). The tool implement may be a toilet plunger or toilet brush, provided that, in an embodiment, the tool implement comprises a combination tool comprising a toilet plunger and toilet brush.

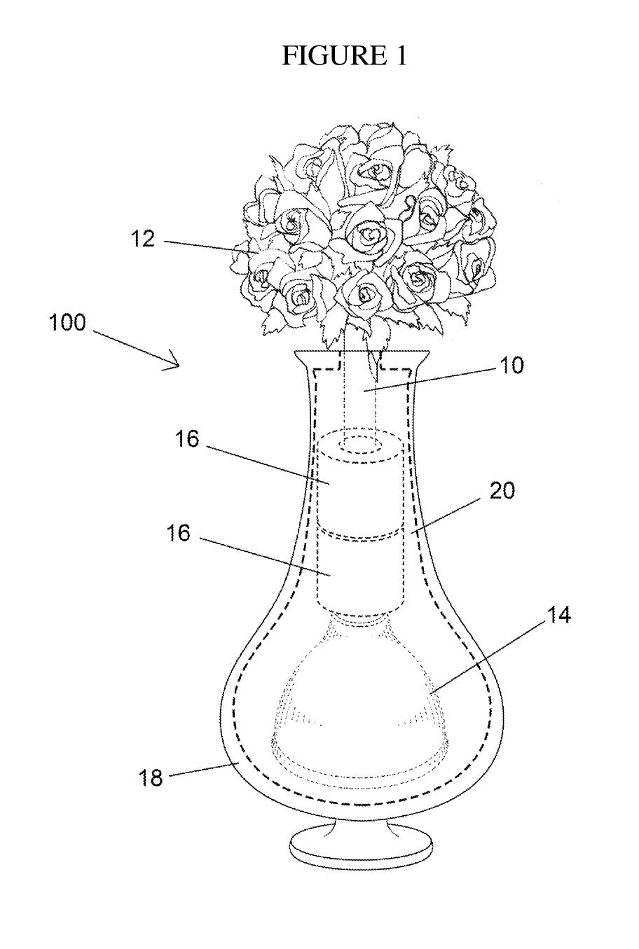

Referring now to FIG. 1, the disclosed bathroom tool is shown in an embodiment at 100. The elongate handle 10 is a solid component that is preferably made of wood, metal, or a hard synthetic (e.g., plastic) material; provided, however, that the elongate handle 10 may comprise any material capable of supporting the bathroom tool 100 and that may be gripped by a human user. The elongate handle 10 includes an aesthetic implement 12 at a first end thereof and a tool implement 14 at a second end thereof. The elongate handle 10 may also include additional features not directly related to the use of the tool implement 14 or the qualities of the aesthetic implement 12. For example, the elongate handle 10 may be of such dimensions and design to accommodate the placement of rolls of toilet paper 16 about it (such that the tube of the toiler paper rolls 16 would be slidably disposed about the length of the elongate handle 10).

The aesthetic implement 12 located at the first end of the elongate handle 10 is any of a plurality of visually pleasing elements for hiding the topmost portions of the bathroom tool. For example, and without exhausting or limiting the availability of other, unlisted, suitable options, the aesthetic implement 12 may comprise any of a flower, a bouquet of flowers, a potpourri container, a decorative tray (such as for receiving other objects thereon), a sports ball (such as a football, baseball, basketball, soccer ball, etc.), an art object (such as a sculpture, a glasswork piece, a metal work piece, or any other artistic item), and a trophy. As will be described in further detail below, the aesthetic implement 12 is removably coupled to the elongate handle 10 such that a user may substitute various aesthetic implements 12 to their customized liking. Furthermore, the aesthetic implement 12 preferably will have a generally flat underside such that, when removed from the bathroom tool 100, the aesthetic implement 12 may rest in a substantially upright orientation on a generally flat surface, such as a floor, cabinet, or table.

A base piece 18 receives at least a part of the bathroom tool 100 and rests on a floor or other generally flat surface to provide foundational support therefor. In a preferred embodiment, the base piece 18 receives the entire tool implement 14 and a portion of the elongate handle 10. In an alternative embodiment, the base piece 18 receives only a portion of the tool implement 14 or all of the tool implement 14, but in any event no part of the elongate handle 10. The base piece 18 includes an opening 20 for receiving the respective portions of the bathroom tool 100, which opening 20 is preferably turned away from a main view of the base piece 18 so as to hide same from view. To further impress upon the aesthetic qualities of the present disclosure, the base piece 18 may comprise an object that is both visually appealing, and, preferably, related to the aesthetic implement 12 coupled to the elongate handle 10. For example, in an embodiment wherein the aesthetic implement 12 is a bouquet of flowers, the base piece 18 may comprise a vase. Without exhausting or limiting the availability of other, unlisted, suitable options, the base piece 18 may instead comprise any of a decorative container (e.g., a cabinet fixture), a decorative stand (e.g., a pillar), a trophy stand, and a sports memorabilia stand.

The tool implement 14 provides the functional utility for the bathroom tool 100 (e.g., the useful operation thereof in maintaining a bathroom fixture, such as a toilet). Although the figure depicts an exemplary embodiment of the tool implement 14 at the second end of the elongate handle 10 as a toilet plunger, in an alternate embodiment, the tool implement 14 may be a toilet brush. It is further contemplated that other types of tool may be used in place of a toilet plunger or toilet brush, provided that they do not otherwise interfere with the operation of the disclosed bathroom tool 100.

It should be noted that the terms “toilet plunger” and “toilet brush” (and similar terms describing same) as used herein include qualities generally known in the art, unless specifically stated the contrary. For example, references to a toilet plunger include an inherent understanding that such toilet plunger is generally resilient and capable of being used as a standard toilet plunger (including without limitation in clearing plumbing blockages), and references to a toilet brush include an inherent understanding that that such toilet brush generally comprises some type of brush element capable of being used as a standard toilet brush (including without limitation in cleaning or scrubbing all or some of a toilet).

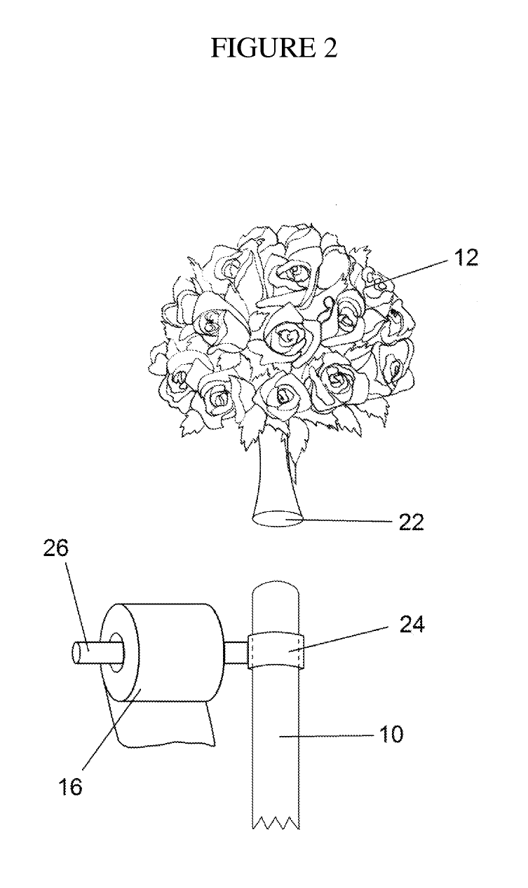

As shown in FIG. 2, the aesthetic implement 12 is removably coupled to the first end of the elongate handle 10 such that the aesthetic implement 12 may be removed from the bathroom tool 100 when necessary, such as during a use operation of the tool implement 14 or wherein the user wishes to display a different aesthetic implement 12. In a preferred embodiment, the removable coupling of the aesthetic implement 12 to the first end of the elongate handle 10 is via a fitted aperture 22 within the aesthetic implement 12 that snuggly receives the first end of the elongate handle 10. In an alternative embodiment, such coupling may be via fastener, snap-fit configuration, threaded engagement, mechanical interference or any other means capable of coupling the aesthetic implement 12 to the elongate handle 10 that does not damage, destroy, or deform either component in such a way to preclude further use thereof (or, in the case of the elongate handle 10, to preclude use with other aesthetic implements 12).

Also depicted is an attachment device 24 removably coupled to a portion of the elongate handle 10. While not necessary for the primary function of the present disclosure, the attachment device 24 offers an additional option for receiving and storing one or more rolls of toilet paper 16 on an elongate arm 26 thereof. It will be apparent that the coupling of the attachment device 24 to the elongate handle 10 may be by way of any suitable engagement that does not damage, destroy, or deform either of the attachment device 24 and the elongate handle 10; provided, however, that in a preferred embodiment, the removable coupling of the attachment device 24 to the elongate handle is by way of a mechanical interference, such as a friction fit clip.

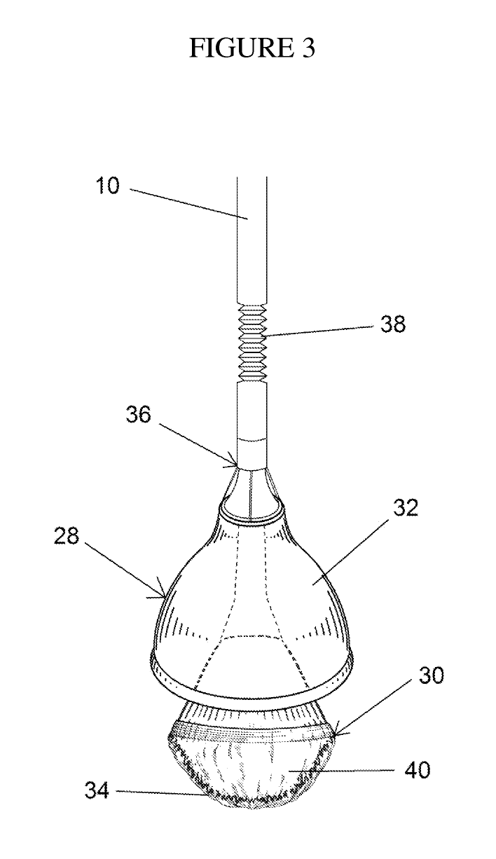

FIG. 3 depicts further embodiments and components of the present disclosure. Namely, shown therein is a preferred embodiment of the tool implement 14 wherein same comprises a combination tool comprising a toilet plunger 28 and toilet brush 30. In such a combination tool, the sidewalls 32 of the toilet plunger 28 would extend beyond the length of any brush portion 34 of the toilet brush 30 such that the bathroom tool would rest on the toilet plunger 28 when in a substantially upright orientation.

The toilet brush 30 and brush portion 34 are provided within an interior surface of the toilet plunger 28, and, in an embodiment, the brush portion 34 comprises a plurality of distinct brush portions. That is, the brush portion may be a single brush element extending downwardly and outwardly from the center of the point of contact between the elongate handle 10 and the tool implement 14, or there may further be one or more brush elements extending outwardly and/or downwardly from the interior surfaces of the plunger sidewalls 32 of the toilet plunger 28. In an embodiment, the brush element comprises an operative grouping standard synthetic bristles. In a further embodiment, the brush element at the end of each such bristle comprises a ball item, which ball item provides greater surface contact for use in cleaning soiled portions of a toilet bowl and which helps to minimize or preclude the build-up of any removed soiling on the brush element itself. Notwithstanding the foregoing, it will be apparent that the brush elements of the brush portion 34 may comprise any embodiment capable of engagingly contacting the various portions of a toilet in order to clean same and otherwise utilize the toilet brush 30.

In a further embodiment, a brush cover 40 may be provided, which would serve as a preferably disposable cover for the brush portion 34 of the toilet brush 30 and would be what directly contacts any portion of the toilet (in contrast to the actual brush portion 34 itself). It will be apparent that the toilet brush 30 and each component thereof will be water resistant regardless of the particular form or embodiment.

In order to provide for greater reach and accessibility by the brush portion 34, the bathroom tool may further comprise a retraction feature 36 capable of slidably adjusting the position of the toilet plunger 28 with respect to the toilet brush 30. In a preferred embodiment, the retraction feature 36 may comprise an o-ring seated around the elongate handle and coupled to the toilet plunger 28, which the user may slide into one of two locked positions in order to retain the position of the toilet plunger 28 with respect to the toilet brush 30. In a first such position, the lower portions of the plunger sidewalls 32 of the toilet plunger 28 may extend beyond the lower portions of the brush portion 34 of the toilet brush 30. In a second such position, the lower portions of the brush portion 34 of the toilet brush 30 may extend beyond the lower portions of the plunger sidewalls 32 of the toilet plunger 28.

The height of the elongate handle 10 may further be adjustable by way of an adjustment feature 38. In an embodiment, the adjustment feature 38 may comprise a telescoping feature for extending the height of the elongate handle 10, wherein the telescoped portions of the adjustment feature 38 are contained within the elongate handle 10 when in a shortened, non-extended position. In another embodiment, the adjustment feature 38 may comprise an accordioning feature for extending the height of the elongate handle 10, wherein the accordioning portions of the adjustment feature 38 are merely compacted when in a shortened, non-extended position.

Furthermore, and alternatively, the disclosed aesthetic implement 12 and corresponding base piece 18 may be provided separately from the disclosed bathroom tool. That is, the aesthetic implement 12 and base piece 18 may be retrofit onto an existing bathroom tool already in a user's possession or control, which may be any bathroom tool comprising an elongate handle capable of being retained in a substantially upright orientation when not in operative use. The aesthetic implement 12 would become coupled to the upper end of the elongate handle of the existing bathroom tool in the same manner as disclosed above, and may further include an elastic or resilient attachment portion for engaging the elongate handle of the existing bathroom tool despite the particular diameter thereof. The base piece 18 would receive the lower portion of the existing bathroom tool and maintain the same in a substantially upright orientation when not in operative use. In this way, the user may still utilize the aesthetically improving features provided by the disclosed invention without requiring an unnecessary purchase where the user already owns such a bathroom tool, but may nonetheless enjoy the benefit of customizing the specific implements so used.

It is noted that a user may interchangeably replace the aesthetic implement 12 as desired to create a customizable visual appeal effect for his or her bathroom. That is, additional aesthetic implements 12 suited for use with the disclosed bathroom tool 100 may be available separately, which additional aesthetic implements 12 may replace or substitute any of same that is presently disposed on the elongate handle 10 of the bathroom tool 100 (and the base piece 18 may be interchanged in the same fashion). In this way, the user is able to keep the visual appearance of the bathroom tool 100 within his or her bathroom, and by extension the room itself, fresh.

In use, the disclosed bathroom tool may be presented within a bathroom to make the room more visually appealing than would be without any such incorporated aesthetic implement. When a user needs to utilize the toilet plunger or toilet brush of the bathroom tool, he or she need only remove the tool from the base piece, locate it operatively appropriately within the toilet bowl, and thereafter commence to utilize such tool implement as necessary until the action is completed. It will be apparent that wherein the aesthetic implement is of a size so as to make utilizing the bathroom tool with the same still attached an awkward endeavor or otherwise gets in the way of the tool's operational use, the user will easily be able to remove the aesthetic implement while performing such action. Where such removal is required, the aesthetic implement may be rested on a flat surface, such as a floor, cabinet, or table. Once the required action is completed, the user may replace the bathroom tool within the base piece (and, if necessary, replace the aesthetic implement on top of the elongate handle).

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A bathroom tool comprising:
an elongate handle having a first end and a second end;
a tool implement disposed at said second end of said elongate handle, said tool implement comprising at least one of a toilet plunger and a toilet brush, said toilet brush comprising at least one brush portion;
an aesthetic implement removably coupled to said first end of said elongate handle; and
a base piece comprising an opening capable of receiving at least a portion of at least one of said tool implement and said elongate handle, said base piece capable of maintaining said tool implement, said elongate handle, and said aesthetic implement in a substantially upright orientation when in non-use,
wherein in commencing a use operation, a user may remove said tool from said base piece and uncouple said aesthetic implement from said first end of said elongate handle, and
wherein upon completing the use operation, the user may replace said tool within said base piece.

2. The tool of claim 1, wherein said aesthetic implement comprises one of at least one flower, a bouquet of flowers, a potpourri container, a decorative tray, a football, a baseball, a soccer ball, a basketball, a trophy, an art object, and a item designed to represent any of the foregoing.

3. The tool of claim 1, wherein said base piece comprises one of a vase, a decorative container, a decorative stand, a trophy stand, and a sports memorabilia stand.

4. The tool of claim 1, wherein an underside portion of said aesthetic implement is capable of maintaining said aesthetic implement in a substantially upright orientation when uncoupled from said first end of said elongate handle and disposed on a generally flat surface.

5. The tool of claim 1, wherein said coupling of said aesthetic implement to said first end of said elongate handle is by way of one of a fitted aperture, a fastener, a threaded engagement, a snap-fit engagement, and a mechanical interference.

6. The tool of claim 1, wherein said at least one brush portion of said toilet brush element comprises one of a plurality of operative grouping standard synthetic bristles and a plurality of bristles having ball items.

7. The tool of claim 1, further comprising a tool cover, said tool cover removably coupled to at least a portion of said tool implement, said tool cover capable of receiving at least a portion of said tool implement.

8. The tool of claim 1, wherein said tool implement comprises a combination tool comprising said toilet plunger and said toilet brush, said toilet brush being generally disposed within an interior portion of said toilet plunger.

9. The tool of claim 8, wherein said toilet plunger is slidably and retractably coupled to said elongate handle by way of a retraction feature such that, based on a position of said toilet plunger with respect to said toilet brush, at least a portion of said toilet plunger may extend beyond said toilet brush or at least a portion of said toilet brush may extend beyond said toilet plunger.

10. The tool of claim 8, wherein said at least one brush portion of said toilet brush comprises one of a plurality of operative grouping standard synthetic bristles and a plurality of bristles having ball items.

11. The tool of claim 8, further comprising a brush cover, said brush cover removably coupled to at least a portion of said combination tool, said brush cover capable of receiving at least a portion of said toilet brush.

12. The tool of claim 1, wherein a height of said elongate handle is adjustable by way of an adjustment feature.

13. The tool of claim 12, wherein said adjustment feature comprises one of a telescoping feature and an accordioning feature.

14. The tool of claim 1, wherein at least a portion of said elongate handle is capable of slidably receiving one or more rolls of toilet paper.

15. The tool of claim 1, further comprising an attachment device removably coupled to a portion of said elongate handle, said attachment device comprising an elongate arm capable of receiving one or more rolls of toilet paper.

16. An aesthetic adornment for a bathroom tool comprising:
an aesthetic implement capable of being removably coupled to an elongate handle of a bathroom tool; and
a base piece comprising an opening capable of receiving at least a portion of the bathroom tool, said base piece capable of maintaining the bathroom tool in a substantially upright orientation when in non-use,
wherein the tool may be retrofit onto an existing bathroom tool, and
wherein in commencing a use operation, a user may remove the bathroom tool from said base piece and uncouple said aesthetic implement from the elongate handle of the bathroom tool, and
wherein upon completing the use operation, the user may replace said tool within said base piece and recouple said aesthetic implement to the bathroom tool.

17. The adornment of claim 16, wherein said aesthetic implement comprises one of at least one flower, a bouquet of flowers, a potpourri container, a decorative tray, a football, a baseball, a soccer ball, a basketball, a trophy, an art object, and a item designed to represent any of the foregoing.

18. The adornment of claim 16, wherein said base piece comprises one of a vase, a decorative container, a decorative stand, a trophy stand, and a sports memorabilia stand.

19. The adornment of claim 16, wherein an underside portion of said aesthetic implement is capable of maintaining said aesthetic implement in a substantially upright orientation when uncoupled from the elongate handle of the bathroom tool and disposed on a generally flat surface.

20. The adornment of claim 16, wherein said coupling of said aesthetic implement to the elongate handle of the bathroom tool is by way of one of a resilient feature, a fastener, a threaded engagement, a snap-fit engagement, and a mechanical interference.
